(19) United States
(12) Patent Application Publication
(10) Pub. No.: US 2013/0224591 A1
(43) Pub. Date: Aug. 29, 2013

(54) ELECTRODE FOR LITHIUM-ION SECONDARY BATTERY, AND LITHIUM-ION SECONDARY BATTERY

(71) Applicants: Yuko Kishimi, Kyoto (JP); Mitsuhiro Kishimi, Kyoto (JP); Toshiyuki Watanabe, Kyoto (JP)

(72) Inventors: Yuko Kishimi, Kyoto (JP); Mitsuhiro Kishimi, Kyoto (JP); Toshiyuki Watanabe, Kyoto (JP)

(73) Assignee: HITACHI, LTD., Tokyo (JP)

(21) Appl. No.: 13/698,239

(22) PCT Filed: Feb. 24, 2012
(86) PCT No.: PCT/JP2012/054519

§ 371 Date: Nov. 15, 2012

(51) Int. Cl. H01M 4/131; H01B 1/02

(52) U.S. Cl. CPC H01M 4/131; H01B 1/02
USPC 429/217; 174/126.2

(57) ABSTRACT

The electrode for a lithium-ion secondary battery of the present invention includes an electrode mixture layer including metal oxide particles having a scaly shape and a new Mohs hardness of 9.0 or more, active material particles capable of intercalating and deintercalating Li, and a resin binder. Further, the lithium-ion secondary battery of the present invention includes a positive electrode, a negative electrode, a nonaqueous electrolyte, and a separator. The positive electrode and/or the negative electrode is the electrode for a lithium-secondary battery of the present invention.

### TECHNICAL FIELD

The present invention relates to a lithium-ion secondary battery having favorable battery characteristics and to an electrode with which the lithium-ion secondary battery can be formed.

### BACKGROUND ART

Lithium-ion secondary batteries have been developed at a rapid pace as batteries used for portable electronic devices, hybrid vehicles, and the like. In such lithium-ion secondary batteries, carbon materials are primarily used as negative electrode active materials, and metal oxides, metal sulfites, a variety of polymers, and the like are used as positive electrode active materials. In particular, lithium composite oxides such as lithium cobaltate, lithium nickelate, and lithium manganate are commonly used as positive electrode active materials for lithium-ion secondary batteries at present because high-voltage and high energy density batteries can be achieved.

As devices using lithium-ion secondary batteries have become more sophisticated, improvements in a variety of characteristics are demanded of lithium-ion secondary batteries at present. In order to fulfill such demands, a number of engineering developments are now under way.

For example, Patent Documents 1 to 3 each propose a technique of containing oxide particles in an active material layer (mixture layer) of a positive or negative electrode. To improve characteristics of a lithium-ion secondary battery, lithium ion conductivity inside the battery may be improved, for example. Patent Documents 1 to 3 describe that through the adoption of the above configuration an SEI (Solid Electrolyte Interface) coating formed in or on the surface of an electrode can have improved lithium ion conductivity.

On the other hand, Patent Document 4, for example, points out that the incorporation of an inorganic powder, such as oxide particles, in a negative electrode leads to deterioration of the wettability of the negative electrode against a nonaqueous electrolyte, thereby inhibiting the entry of lithium ions into the negative electrode active material layer. To avoid such a problem, Patent Document 4 proposes to surface-treat the inorganic powder with higher fatty acid or a metal salt thereof before using it in the negative electrode.

### PRIOR ART DOCUMENTS

### Patent Documents

Patent Document 1: JP 10-255842 A

Patent Document 2: JP 2004-200176 A

Patent Document 3: JP 2007-305545 A

Patent Document 4: JP 11-73969 A

### DISCLOSURE OF INVENTION

### Problem to be Solved by the Invention

With the foregoing in mind, it is an object of the present invention to provide, through a different approach from conventional approaches, a lithium-ion secondary battery with favorable battery characteristics and an electrode with which the lithium-ion secondary battery can be formed.

### Means for Solving Problem

In order to achieve the above object, the electrode for a lithium-ion secondary battery of the present invention includes an electrode mixture layer including metal oxide particles having a scaly shape and a new Mohs hardness of 9.0 or more, active material particles capable of intercalating and deintercalating Li, and a resin binder.

Further, the lithium-ion secondary battery of the present invention includes a positive electrode, a negative electrode, a nonaqueous electrolyte, and a separator. The positive electrode and/or the negative electrode is the electrode for a lithium-ion secondary battery of the present invention.

### Effects of the Invention

According to the present invention, it is possible to provide a lithium-ion secondary battery having favorable battery characteristics, and an electrode with which the lithium-ion secondary battery can be formed.

### DESCRIPTION OF THE INVENTION

The electrode for a lithium-ion secondary battery (hereinafter, it may be simply referred to as the “electrode”) of the present invention includes an electrode mixture layer including metal oxide particles, active material particles capable of intercalating and deintercalating Li, and a resin binder, and the electrode is configured to have the electrode mixture layer on one side or both sides of a current collector. The electrode of the present invention is used as a positive electrode or a negative electrode of a lithium-ion secondary battery

A resin binder used, for example, to bind active material particles together in an electrode mixture layer of an electrode for a lithium-ion secondary battery is present in the electrode mixture layer in a cluster, and delivers strong binding capacity. On the other hand, when the resin binder components are tightly bounded together, paths (passages) of a nonaqueous electrolyte may not be ensured at some parts of the electrode mixture layer. Further, when the resin binder is present in a cluster at certain portions, the distribution of the resin binder may become uneven in the electrode mixture layer in a micro range. These factors inhibit the dispersion of lithium ions in the electrode mixture layer.

The electrode of the present invention includes metal oxide scaly particles in the electrode mixture layer, so that at least a part of the metal oxide scaly particles will be in the resin binder in the electrode mixture layer. As a result, the resin binder components do not bind together in a cluster at certain portions but are bound together with a number of gaps. Consequently, the resin binder will be distributed evenly in the electrode mixture layer in small amount. For this reason, in the electrode of the present invention, paths of a nonaqueous electrolyte are formed favorably in the electrode mixture layer, so that the diffusibility of lithium ions improves. Therefore, a lithium-ion secondary battery using the electrode of the present invention (i.e., the lithium-ion secondary battery of the present invention) will have more favorable battery characteristics including load characteristics.

Further; the effect of suppressing expansion and contraction of the resin binder improves. This is presumably because the function of the resin binder as a carrier improves due to the metal oxide particles included in the electrode mixture layer being scaly. Thus, even if active material particles swell or contract along with charging and discharging of the battery, swelling and contraction of the electrode mixture layer as a whole can be suppressed in the electrode of the present invention. For this reason, a lithium-ion secondary battery using the electrode of the present invention (i.e., the lithium-ion secondary battery of the present invention) is expected to have, for example, improved charge-discharge cycle characteristics.

Generally, electrodes for lithium-ion secondary batteries are produced through a process involving dispersing active materials, a binder and the like in a solvent to prepare a composition for forming an electrode mixture layer, and applying the composition to a current collector. In the step of preparing the electrode mixture layer forming composition, shearing stress or the like is applied to the components of the composition at the time of dispersion. Thus, when metal oxide scaly particles are used in the preparation of the electrode mixture layer forming composition, the particles may be cracked and unable to preserve their scaly shape. With an electrode having an electrode mixture layer containing such metal oxide particles, the effects as mentioned above may not be ensured favorably.

Therefore, the electrode of the present invention uses hard metal oxide scaly particles having a new Mohs hardness of 9.0 or more. Thus, even if the production method mentioned above is adopted, deformation of the metal oxide particles can be suppressed as much as possible during the production process, so that each of the effects resulting from the metal oxide particles can be delivered favorably.

Examples of the metal oxide scaly particles include particles of α-aluminum oxide, particles of tetragonal or cubic zirconium oxide, and particles of metal oxide obtained by stabilizing α-aluminum oxide, tetragonal zirconium oxide or cubic zirconium oxide with a stabilizer.

Further; when the metal oxide of which the metal oxide scaly particles are made is stabilized with a stabilizer, the stabilizer is preferably at least one selected from the group consisting of magnesium oxide, calcium oxide, and yttrium oxide. Furthermore, the amount of the stabilizer added to the stabilized metal oxide is preferably 15 mass % or less, and preferably 5 mass % or more.

Those mentioned above as the examples of the metal oxide scaly particles may be used alone or in combination of two or more.

As for the shape, the metal oxide scaly particles have an aspect ratio D/t of preferably 4 or more, and more preferably 6 or more, where the aspect ratio D/t is represented by a ratio between the maximum planar diameter D (μm) and the thickness t (μm). When the metal oxide particles have a scaly shape with such an aspect ratio, the effect of forming paths of a nonaqueous electrolyte in the electrode mixture layer and the effect of suppressing swelling and contraction of the electrode mixture layer can be ensured more favorably. However, if the aspect ratio of the metal oxide scaly particles is too large, the effect of suppressing cracks or the like during the preparation of the electrode mixture layer forming composition, which is the result of the metal oxide scaly particles having the above new Mohs hardness, may decline. Therefore, the aspect ratio D/t of the metal oxide scaly particles is preferably 30 or less, and more preferably 20 or less.

Further, if the size of the metal oxide scaly particles is too small, the effects resulting from the use of the metal oxide scaly particles may decline. Therefore, the average of the maximum planar diameters D (μm) is preferably 0.1 μm or more, and more preferably 0.5 μm or more. On the other hand, if the size of the metal oxide scaly particles is too large, the direct current resistance of the electrode may increase. Therefore, the average of the maximum planar diameters D (μm) of the metal oxide scaly particles is preferably 5 μm or less, and more preferably 2 μm or less.

The aspect ratio of the metal oxide scaly particles as used herein refers to a value calculated from the average of the maximum planer diameters D and the average of the thicknesses t that are obtained as follows. The particles are observed under a scanning electron microscope (SEM) to measure the maximum planar diameter D (the length of the longest distanced part of the plane of a particle with the largest area) of 50 particles to determine the average (the average determined by dividing the total of the maximum planer diameters D (_82 m) of 50 particles by the number (50) of the particles) and to measure the thickness t (μm) of 50 particles to determine the average (the average determined by dividing the total of the thicknesses t (μm) of 50 particles by the number (50) of the particles).

Further, the average of the maximum planer diameters D (μm) of the metal oxide scaly particles as used herein refers to the average of the maximum planer diameters D used in calculating the aspect ratio.

For the metal oxide scaly particles, not only commercially available products can be used but also particles having a shape other than scaly (e.g., spherical) may be pulverized to form metal oxide scaly particles.

In terms of ensuring the effects resulting from the use of the metal oxide scaly particles more favorably in the electrode of the present invention, the content of the metal oxide scaly particles in the electrode mixture layer is preferably 0.01 parts by mass or more, and more preferably 0.5 parts by mass or more with respect to 100 parts by mass of the active material particles contained in the electrode mixture layer. However, if the amount of the metal oxide scaly particles in the electrode mixture layer becomes too large, a large amount of insulative substances is present in the electrode mixture layer, thereby causing an increase in the direct current resistance of the electrode. Thus, the content of the metal oxide scaly particles in the electrode mixture layer is preferably 2 parts by mass or less, and more preferably 1.5 parts by mass or less with respect to 100 parts by mass of the active material particles contained in the electrode mixture layer.

When using the electrode of the present invention as a negative electrode for a lithium-ion secondary battery, particles of conventionally-known active materials used in negative electrodes of lithium-ion secondary batteries, i.e., particles of active materials capable of intercalating and deintercalating Li can be used as the active material particles. Specific examples of such active material particles include: particles of carbon materials such as graphites [such as natural graphite; and artificial graphite obtained by graphitizing an easily graphitizable carbon material such as pyrolytic carbons, mesophase carbon microbeads (MCMB), or carbon fibers at 2,800° C. or higher], pyrolytic carbons, cokes, glassy carbons, calcined organic polymer compounds, MCMB, carbon fibers, and active carbons; and particles of metals capable of being alloyed with lithium (such as Si and Sn) and materials containing these metals (such as alloys and oxides). When using the electrode of the present invention as a negative electrode for a lithium-ion secondary battery, these active material particles may be used alone or in combination of two or more.

Among the negative electrode active materials mentioned above, it is preferable to use materials including Si and I as constituent elements (where an atomic ratio x of O to Si is 0.5≦x≦1.5; hereinafter, these materials will be referred to as “SiOₓ”) especially in terms of increasing the capacity of the battery

SiOₓ may include microcrystalline Si or amorphous Si. In this case, the atomic ratio between Si and O is a ratio including the microcrystalline Si or the amorphous Si. That is, SiOₓ includes one having a structure in which Si (e.g., microcrystalline Si) is dispersed in an amorphous SiO₂matrix. In this case, the atomic ratio x, including the amorphous SiO₂ and the Si dispersed in the amorphous SiO₂, may satisfy 0.5≦x≦1.5. For example, in the case of a material having a structure in which Si is dispersed in an amorphous SiO₂ matrix and a molar ratio of SiO₂ to Si is 1:1, x of this material is 1(x=1). Therefore, the material is represented by the composition formula SiO. When a material having such a structure is analyzed by, for example, X-ray diffractometry, a peak resulting from the presence of Si (microcrystalline Si) may not be observed. However, the presence of fine Si can be found when the material is observed under a transmission electron microscope.

Since SiOₓ is poor in conductivity, the surface of SiOₓ may be coated with carbon. As a result, a conductive network in the negative electrode can be formed more favorably.

For example, low crystalline carbons, carbon nanotubes and vapor deposition carbon fibers can be used to coat the surface of SiOₓ.

If the surface of SiOₓ is coated with carbon by heating hydrocarbon gas in a vapor phase, and depositing on the surface of the SiOₓ particles carbon produced by the thermal decomposition of the hydrocarbon gas [chemical vapor deposition (CVD) method], it is possible to distribute the hydrocarbon gas throughout the SiOₓ particles and to form a thin and uniform coating containing conductive carbon (carbon coating layer) on the surface of the particles and in holes in the surface. Thus, conductivity can be imparted to the SiOₓ particles uniformly using a small amount of carbon.

Although toluene, benzene, xylene, mesitylene or the like can be used as the liquid source of the hydrocarbon gas used in the CVD method, toluene is particularly preferable because of its ease of handling. The hydrocarbon gas can be obtained by evaporating any of these liquid sources (e.g., bubbling the liquid source with nitrogen gas). Further, it is also possible to use methane gas, ethylene gas and acetylene gas.

The treatment temperature in the CVD method is preferably, for example, 600 to 1200° C. Further, SiOₓ to be subjected to CVD is preferably a granule (composite particles) granulated by a known method.

When coating the surface of SiOₓₚ with carbon, the amount of carbon is preferably 5 parts by mass or more, and more preferably 10 parts by mass or more, and preferably 95 parts by mass or less, and more preferably 90 parts by mass or less with respect to 100 parts by mass of SiOₓ.

As with other high-capacity negative electrode materials, SiOₓ undergoes a large volume change associated with charging and discharging of the battery. Therefore, it is preferable to use SiOₓ and graphite in combination as negative electrode active materials. As a result, while achieving an increase in the capacity resulting from the use of SiOₓ, swelling and contraction of the negative electrode associated with charging and discharging of the battery can be suppressed and the charge-discharge cycle characteristics can be maintained at a higher level.

When using SiOₓ and graphite in combination as negative electrode active materials, SiOₓ makes up preferably 0.5 mass % or more of the total amount of the negative electrode active materials in terms of favorably ensuring the effect of increasing the capacity resulting from the use of SiOₓ. Further, in term of suppressing swelling and contraction of the negative electrode due to SiOₓ, SiOₓ makes up preferably 10 mass % or less of the total amount of the negative electrode active materials.

When using the electrode of the present invention as a positive electrode for a lithium-ion secondary battery, particles of conventionally-known active materials used in positive electrodes of lithium-ion secondary batteries, i.e., particles of active materials capable of intercalating and deintercalating Li can be used as the active material particles. Specific examples of such active material particles include particles of layer-structured lithium-containing transition metal oxides represented by Li_{1+c}M¹O₂ (−0.1<c<0.1, M¹: Co, Ni, Mn, Al, Mg, or the like), spinel-structured lithium manganese oxides such as LiMn₂O₄ and one obtained by replacing a part of the elements of LiMn₂O₄ with a different element, and olivine-type compounds represented by LiM²PO₄ (M²: Co, Ni, Mn, Fe, or the like). Specific examples of the layer-structured lithium-containing transition metal oxides include, in addition to LiCoO₂ and LiNi_{1-d}Co_{d-e}AlₑO₂(0.1≦d≦0.3, 0.01≦e≦0.2), oxides containing at least Co, Ni and Mn (LiMn_{1/3}Mi_{1/3}Co_{1/3}O₂, LiMn_{5/12}Ni_{5/12}Co_{1/6}O₂, LiMn_{3/5} Co_{1/5}O₂, and the like). When using the electrode of the present invention as a positive electrode for a lithium-ion secondary battery, these active material particles may be used alone or in combination of two or more.

When using the electrode of the present invention as a negative electrode for a lithium-ion secondary battery or as a positive electrode for a lithium-ion secondary battery, the average particle size of primary particles of the active material particles is preferably 50 nm or more, and preferably 500 μm or less, and more preferably 10 μm or less.

The average particle size of primary particles of the active material particles as used herein refers to an average value obtained by determining the particle diameter (when the particles are spherical) or the dimension of the longitudinal axis (when the particles have a shape other than spherical) of 300 primary particles of the active material particles observed with a transmission electron microscope (TEM), and dividing the total of these particle sizes by the number (300) of the particles.

As the resin binder used in the electrode mixture layer of the electrode of the present invention, it is possible to use conventionally-known resin binders used in positive electrode mixture layers of positive electrodes and in negative electrode mixture layers of negative electrodes for lithium-ion secondary batteries. Specifically, preferred examples thereof include polyvinylidene fluoride (PVDF), polytetrafluoroethylene (PTFE), styrene butadiene rubber (SBR), and carboxymethyl cellulose (CMC).

Further, a conductive assistant can also be contained as needed in the electrode mixture layer of the electrode of the present invention. Specific examples of conductive assistants include: graphites such as natural graphite (e.g., scaly graphite) and artificial graphite; carbon blacks such as acetylene black, Ketjen black, channel black, furnace black, lamp black, and thermal black; and carbon fibers.

Furthermore, it is preferable to include in the electrode mixture layer of the electrode of the present invention oxide particles whose primary particles have an average particle size of 1 to 20 nm and having no peak or having a width at half height of the highest intensity peak of 1.0° or more within the range of 2 θ=20 to 70° in a powder X-ray diffraction spectrum. That is, these oxide particles have low crystallinity or are amorphous. Hereinafter, they will be referred to as “low crystalline oxide particles.”

In the electrode mixture layer containing the low crystalline oxide particles, lithium ion diffusion polarization can be reduced by the influence of elements (metallic elements) contained in the low crystalline oxide particles. Further, the surface properties of the active material in the electrode change due to the low crystalline oxide particles added, and therefore the interface resistance between the electrode (the active material contained therein) and the nonaqueous electrolyte can be reduced in a battery using the electrode. Thus, when the electrode of the present invention also includes the low crystalline oxide particles, the load characteristics of the lithium-ion secondary battery using the electrode of the present invention can be improved further.

Further, when the electrode of the present invention includes the low crystalline oxide particles, the nonaqueous electrolyte contained in the battery can be introduced smoothly into the electrode mixture layer due to the surface polarity of the low crystalline oxide particles. For this reason, even if the thickness of the electrode mixture layer is increased, for example, the utilization efficiency of the active material of the electrode will not decline, and therefore it is possible to further improve the charge-discharge cycle characteristics of a battery using the electrode of the present invention, and also increase the capacity of the battery even further.

The average particle size of primary particles of the low crystalline oxide particles is preferably 20 nm or less, and more preferably 10 nm or less. With such fine oxide particles, the effect of improving the battery load characteristics can be delivered favorably. However, when the size of the low crystalline oxide particles is too small, it is difficult to produce the low crystalline oxide particles and the ease of handing of the low crystalline oxide particles deteriorates. Therefore, the average particle size of primary particles of the low crystalline oxide particles is preferably 1 nm or more, and more preferably 1.5 nm or more.

The average particle size of primary particles of the low crystalline oxide particles as used herein refers to an average value obtained by determining the particle diameter (when the particles are spherical) or the dimension of the longitudinal axis (when the particles have a shape other spherical) of 300 primary particles of the oxide particles observed with a transmission electron microscope, and dividing the total of these particle sizes by the number (300) of the particles. However, if the size of the low crystalline oxide particles is too small and is difficult to determine by the above method, then the average particle size of the primary particles may be determined by small angle X-ray scattering.

It is preferable that the low crystalline oxide particles have no peak or have a width at half height of the highest intensity peak of 1.0° or more, preferably 1.5° or more within the range of 2 θ=20 to 70° in a powder X-ray diffraction spectrum.

With oxide particles having such low crystallinity, the effect of improving the load characteristics of the battery can be delivered favorably.

Furthermore, the specific surface area of the low crystalline oxide particles determined by nitrogen gas adsorption is preferably 30 m²/g or more, more preferably 100 m²/g or more, and preferably 500 m²/g or less. When the low crystalline oxide particles have the specific surface area as above, the effect of improving the battery load characteristics improves further. The reason seems to be as follows: Many dangling bonds remain, for example, on the top surface of the low crystalline oxide particles having low crystallinity and a large structure, i.e., having the specific surface area as above, and thus these dangling bonds promote dissociation of lithium ions in the nonaqueous electrolyte, resulting in a further decline in the lithium ion diffusion polarization.

The specific surface area of the low crystalline oxide particles as used herein refers to a specific surface area of the surface and micropores of the low crystalline oxide particles obtained by measuring the surface area and performing calculation by the BET method, which is a theory for multilayer adsorption. Specifically, it is a value obtained as the BET specific surface area by carrying out a measurement using an automatic specific surface area/pore size distribution measurement device (device model: BELSORP-mini) manufactured by BEL Japan, Inc., up to a relative pressure of 0.99 to a saturated vapor pressure. Further, the pressure at the start of measurement is used as the saturated vapor pressure, the actual measured value is used as the dead volume, and the drying conditions prior to measurement is for two hours at 80° C. in a nitrogen gas flow.

In terms of ease of providing an oxide with lower crystallinity, examples of the oxide of which the low crystalline oxide particles is made include oxides containing at least one element selected from the group consisting of Si, Zr, Al, Ce, Mg, Ti, Ba, and Sr. Note that the oxide of which the low crystalline oxide particles is made may be a hydrate of an oxide. Specific examples of such oxides include SiOₚ (p=1.7 to 2.5), ZrO_{y} (y=1.8 to 2.2), ZrO₂.nH₂O (n=0.5 to 10), AlOOH, Al(OH)₃, CeO₂, MgO_{z} (z=0.8 to 1.2), MgOₐ.mH2O (a=0.8 to 1.2, m=0.5 to 10), TiO_{b} (b=1.5 to 2), BaTiO₃, SrO, SrTiO₃, and Ba₂O₃. Further, each of the oxides may be an oxide whose element is replaced with another element, containing an element other than the above-described elements as long as the element can be replaced at the site of the metallic element without breaking the bonds of the oxide. Examples thereof include an oxide obtained by partially replacing Zr of the above-mentioned ZrO_{y} with Y. Further, it is also possible to use, for example, an oxide obtained by partially replacing Ti of TiBaO₃ with Sr. For example, these oxides may be used alone or in combination of two or more to form the low crystalline oxide particles.

Any synthesis method may be adopted as the method for synthesizing the low crystalline oxide particles, as long as oxide particles with low crystallinity can be obtained. However, it is technically difficult to achieve both low crystallinity and small primary particle size. In order to synthesize oxide particles having such a structure and form, it is preferable to adopt a synthesis method involving an oxidation treatment in an aqueous solution, such as a precipitation method or a hydrothermal treatment (hydrothermal synthesis) with a low heating temperature.

When synthesizing the oxide particles by a synthesis method involving the above-described oxidation treatment in an aqueous solution, the starting material needs to be dissolved in water, and it is therefore preferable to use a water-soluble salt containing an element constituting the low crystalline oxide particles (an element other than oxygen). Examples of such a water-soluble salt include sulfates, nitrates, chlorides, and the like that contain an element constituting the low crystalline oxide particles.

In the synthesis method involving an oxidation treatment in an aqueous solution, an aqueous solution of the above-described starting material (water-soluble salt) is neutralized by introducing thereto an aqueous alkaline solution such as ammonia water or an aqueous solution of alkaline metal hydroxide such as sodium hydroxide, and a precipitate is formed by a coprecipitation method, followed by an oxidation treatment of the precipitate in an aqueous solution. As the oxidation treatment in an aqueous solution, it is possible to adopt, for example, a method in which oxygen, or a gas containing oxygen, such as air, is oxidized by bubbling while stirring, and a hydrothermal treatment method in which heat treatment is carried out under pressure. Although a method in which oxidation is performed by separately adding an oxidizing agent is also conceivable, care should be taken in selecting the oxidizing agent because the oxidizing agent may remain as an impurity. In the case of the precipitation method, the oxidation by bubbling may be carried out concurrently with the coprecipitation, and a suspension containing the produced precipitate is fully washed, and the precipitate is extracted from the solution by filtration or the like, followed by drying, to yield low crystalline oxide particles.

In the case of the hydrothermal treatment method, a suspension (aqueous solution containing the above-described precipitate) obtained by the coprecipitation method is heated in a sealed container to heat-treat the suspension under pressure, then the suspension is fully washed before the precipitate is extracted by filtration, followed by drying, to yield low crystalline oxide particles. In particular, it is preferable that SiOₚ, Zr₂.nH₂O, AlOOH, Al(OH)₃, MgOₐ.mH₂O, and the like as described above are subjected to a hydrothermal treatment to yield a glassy precipitate, then the precipitate is extracted, and subjected to a drying step, to yield low crystalline oxide particles.

It is preferable that the pH of the suspension used in the hydrothermal treatment method is set to 4 to 11 by adjusting the amount of the aqueous alkaline solution added, and the pH may be selected from this range such that the desired oxide can be precipitated. For example, in the case of oxides from which a glassy precipitate can be obtained by the hydrothermal treatment as in the cases of SiOₚ, ZrO₂.nH₂O, AlOOH, Al(OH)₃, and MgOₐ.mH₂O as described above, it is more preferable that the pH of the suspension is in a range of weakly acidic to neutral, i.e., in a range of 4 to 7. Further, also in the case of synthesizing oxide particles by the above-described precipitation method, it is preferable that the pH after introduction of the aqueous alkaline solution into the aqueous solution of the starting material is similar to the above-described pH of the suspension used in the hydrothermal treatment method.

The heating temperature in the hydrothermal treatment method is preferably 60° C. or more, and preferably 200° C. or less. Note that it is more preferable to select, as the heating temperature, a temperature that is sufficiently low such that low crystalline oxide particles will not undergo excessive crystallization. Specifically, the heating temperature is more preferably 80° C. or more, and more preferably 150° C. or less, and further preferably 120° C. or less.

Further, it is preferable that the heating time in the hydrothermal treatment method is one hour or more in terms of suppressing the formation of particles for which oxidative dehydrogenation has not been sufficiently performed. However, if the heating time is too long in the case of adopting the hydrothermal treatment method, the characteristics of the synthesized low crystalline oxide particles will not be affected significantly, but the state of the low crystalline oxide particles will no longer change after reaching a saturation reaction state that is determined by the pH of the suspension and the heating temperature. Therefore, the heating time in the hydrothermal treatment method is preferably 40 hours or less, and more preferably 6 hours or less.

When using the low crystalline oxide particles in the electrode of the present invention, in terms of favorably ensuring the effects resulting from the use of the low crystalline oxide particles, the percentage of the low crystalline oxide particles is preferably 0.1 mass % or more, and more preferably 0.5 mass % or more, where the total of the low crystalline oxide particles and the active material particles contained in the electrode mixture layer is taken as 100 mass %. However, when the amount of the low crystalline oxide particles contained in the electrode mixture layer is too large, a large amount of insulating substances is present in the electrode mixture layer, and thus the direct current resistance of the electrode may increase. Therefore, the percentage of the low crystalline oxide particles is preferably 10 mass % or less, and more preferably 5 mass % or less, where the total of the low crystalline oxide particles and the active material particles contained in the electrode mixture layer is taken as 100 mass %.

When using the electrode of the present invention as a negative electrode for a lithium-ion secondary battery, it is preferable that the composition of the components of the electrode mixture layer (negative electrode mixture layer) is made up of 85 to 99 mass % of the active material particles, and 1.0 to 10 mass % of the resin binder, for example. Further, in the case of using a conductive assistant, the amount of the conductive assistant in the electrode mixture layer is preferably 0.5 to 10 mass %. Also, the thickness of the electrode mixture layer (negative electrode mixture layer) (when forming the electrode mixture layer on one side or both sides of a current collector, the thickness per side of the current collector) is preferably 30 to 150 μm.

When the electrode of the present invention is used as a negative electrode for a lithium-ion secondary battery including a current collector, it is possible to use foil, punched metal, mesh, expanded metal, and the like made of copper or nickel as the current collector. Generally, copper foil is used. The thickness of the current collector is preferably 5 to 30 μm.

When the electrode of the present invention is used as a positive electrode for a lithium-ion secondary battery, it is preferable that the composition of the components of the electrode mixture layer (positive electrode mixture layer) is made up of 75 to 95 mass % of the active material particles, 2 to 15 mass % of the resin binder, and 2 to 15 mass % of the conductive assistant, for example. Also, the thickness of the electrode mixture layer (positive electrode mixture layer) (when forming the electrode mixture layer on one side or both sides of a current collector, the thickness per side of the current collector) is preferably 30 to 180 μm.

When the electrode of the present invention is used as a positive electrode for a lithium-ion secondary battery including a current collector, it is possible to use foil, punched metal, mesh, expanded metal, and the like made of aluminum as the current collector. Generally, aluminum foil is used. The thickness of the current collector is preferably 10 to 30 μm.

The electrode of the present invention can be produced, for example, through a process involving applying, to one or both sides of the current collector, an electrode mixture-containing composition (paste, slurry, or the like) prepared by dispersing, in a solvent, including, for example, an organic solvent such as N-methyl-2-pyrrolidone (NMP) and water, an electrode mixture containing the metal oxide scaly particles, the active material particles, and the resin binder, and optionally the conductive assistant and the low crystalline oxide particles; drying; and optionally performing pressing.

Further, after the formation of the electrode mixture layer, it is possible to provide, by an ordinary method, the electrode with a lead portion for connecting the electrode to a terminal in the battery.

The lithium-ion secondary battery (hereinafter, it may be simply referred to as the “battery”) of the present invention includes a positive electrode, a negative electrode, a nonaqueous electrolyte, and a separator. At least one of the positive electrode and the negative electrode may be the electrode for a lithium-ion secondary battery of the present invention. There is no particular limitation to the other configuration and structure, and it is possible to use various configurations and structures that are adopted in conventionally-known lithium-ion secondary batteries.

In the battery of the present invention, only one of the positive electrode and the negative electrode may be the electrode of the present invention, or both the positive electrode and the negative electrode may be the electrode of the present invention. When only the negative electrode of the battery of the present invention is the electrode of the present invention, a positive electrode having the same configuration as the electrode of the present invention (positive electrode) except for not containing the oxide particles can be used as the positive electrode. When only the positive electrode of the battery of the present invention is the electrode of the present invention, a negative electrode having the same configuration as the electrode of the present invention (negative electrode) except for not containing the oxide particles can be used as the negative electrode.

It is preferable that the separator of the battery of the present invention has the property of closing the pores (i.e., shutdown function) at a temperature of 80° C. or more (more preferably 100° C. or more) and 170° C. or less (more preferably 150° C. or less). It is possible to use a separator used for commonly used lithium-ion secondary batteries and the like, including, for example, a microporous film made of polyolefin such as polyethylene (PE) or polypropylene (PP). The microporous film constituting the separator may be a microporous film using only PE or only PP, for example, or may be a laminate of a PE microporous film and a PP microporous film. The thickness of the separator is preferably 10 to 30 μm, for example.

The above positive electrode and the above negative electrode and the above separator can be used in the battery of the present invention in the form of a laminated electrode body obtained by placing the positive electrode and the negative electrode on one another through the separator, or in the form of a wound electrode body that is formed by further winding the laminated electrode body in a spiral fashion.

As the nonaqueous electrolyte of the battery of the present invention, it is possible to use a nonaqueous electrolyte prepared, for example, by dissolving at least one lithium salt selected, for example, from LiClO₄, LiPF₆, LiBF₄, LiAsF₆, LiSbF₆, LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (n≧2), and LiN(R_{f}OSO₂)₂ (where R_{f} is a fluoroalkyl group) in an organic solvent such as dimethyl carbonate, diethyl carbonate, methyl ethyl carbonate, methyl propionate, ethylene carbonate, propylene carbonate, butylene carbonate, γ-butyrolactone, ethylene glycol sulfite, 1,2-dimethoxyethane, 1,3-dioxolane, tetrahydrofuran, 2-methyl-tetrahydrofuran, or diethyl ether. The concentration of the lithium salt in the nonaqueous electrolyte is preferably 0.5 to 1.5 mol/L, and particularly preferably 0.9 to 1.25 mol/L. For the purpose of improving the characteristics such as safety, charge-discharge cycle characteristics, high temperature storability, an additive such as vinylene carbonates, 1,3-propanesultone, diphenyl disulfide, cyclohexyl benzene, biphenyl, fluorobenzene, or t-butyl benzene can be added to the electrolyte as appropriate.

Further, a known gelling agent such as a polymer may be added to the nonaqueous electrolyte, and the nonaqueous electrolyte may be used in the form of a gel (gel electrolyte).

In terms of the form, the lithium-ion secondary battery of the present invention can be, for example, a cylindrical (e.g., rectangular cylindrical or circular cylindrical) battery that uses a steel can or an aluminum can as the outer case can, or may be a soft package battery using a metal-evaporated laminated film as an outer case member.

### EXAMPLES

Hereinafter, the present invention will be described in detail by way of Examples. Note that the present invention is not limited to the following Examples.

### Example 1

<Preparation of Negative Electrode Mixture-Containing Composition>

98 parts by mass of scaly graphite (manufactured by Hitachi Chemical Co., Ltd., average particle size of primary particles: about 450 μm), 1 part by mass of acetylene black, and 1 part by mass of CMC were dispersed in water to prepare a negative electrode mixture-containing composition, and then the composition was applied onto one side of a 8 μm-thick copper foil as a current collector with an applicator. The applied composition was dried, and then pressed. Subsequently, the current collector was cut into a size of 35 mm×35 mm, thus obtaining a negative electrode. The thickness of the negative electrode mixture layer of the obtained negative electrode was 98 μm.

<Preparation of Positive Electrode Mixture-Containing Composition>

93.7 parts by mass of Li_{1.02}Ni_{0.5}Mn_{0.2}Co_{0.3}O₃ as a positive electrode active material (average particle size of primary particles: 15 μm), 4 parts by mass of acetylene black, 2 parts by mass of PVDF, and 0.3 parts by mass of polyvinyl pyrrolidone were dispersed in NMP, and yttria-stabilized zirconia scaly particles (new Mohs hardness: 9.0, aspect ratio D/t: 5.6, average of the maximum planer diameters D: 0.8 μm, amount of yttria added: 10 mass %) was further dispersed in the NMP such that the amount of the yttria-stabilized zirconia scaly particles was 0.3 parts by mass with respect to 100 parts by mass of the positive electrode active material, thus preparing a positive electrode mixture-containing composition. The composition was applied onto one side of a 15 μm-thick aluminum foil as a current collector with an applicator. The applied composition was dried, and then pressed. Subsequently, the current collector was cut into a size of 30 mm×30 mm, thus obtaining a positive electrode. The thickness of the positive electrode mixture layer of the obtained positive electrode was 75 μm.

<Production of Lithium-Ion Secondary Battery (Test Cell)>

The positive electrode and the negative electrode obtained above were laminated through a separator (PE microporous film having a thickness of 16 μm) and were placed in a laminated film outer package. A nonaqueous electrolyte (a solution obtained by dissolving LiPF₆ at a concentration of 1.2M in a mixed solvent of ethylene carbonate and diethyl carbonate at a volume ratio of 2:8) was injected into the laminated film outer package, and then the laminated film outer package was sealed, thus obtaining a test cell. The design capacity of the test cell obtained was 28 mAh (the same is true for each of the test cells of Examples 2 to 9 and Comparative Examples 1 to 3 described below).

### Example 2

A positive electrode mixture-containing composition was prepared in the same manner as in Example 1 except that different yttria-stabilized zirconia scaly particles (new Mohs hardness: 9.0, aspect ratio D/t: 4.3, average of maximum planer diameters D: 2.0 μm, amount of yttria added: 10 mass %) were used, and 1 part by mass of the yttria-stabilized zirconia scaly particles were added with respect to 100 parts by mass of the positive electrode active material. Except for using this positive electrode mixture-containing composition, a positive electrode was produced in the same manner as in Example 1. And except for using this positive electrode, a test cell (lithium-ion secondary battery) was produced in the same manner as in Example 1.

### Example 3

A positive electrode mixture-containing composition was prepared in the same manner as in Example 1 except that tetragonal zirconia scaly particles (new Mohs hardness: 9.0, aspect ratio D/t: 6.5, average of maximum planer diameters D: 0.1 μm) were used in place of the yttria-stabilized zirconia scaly particles, and 0.05 parts by mass of the tetragonal zirconia scaly particles were added with respect to 100 parts by mass of the positive electrode active material. Except for using this positive electrode mixture-containing composition, a positive electrode was produced in the same manner as in Example 1. And except for using this positive electrode, a test cell (lithium-ion secondary battery) was produced in the same manner as in Example 1.

### Example 4

A positive electrode mixture-containing composition was prepared in the same manner as in Example 1 except that 3.0 parts by mass of the yttria-stabilized zirconia scaly particles were added with respect to 100 parts by mass of the positive electrode active material. Except for using this positive electrode mixture-containing composition, a positive electrode was produced in the same manner as in Example 1. And except for using this positive electrode, a test cell (lithium-ion secondary battery) was produced in the same manner as in Example 1.

### Example 5

<Preparation of Negative Electrode Mixture-Containing Composition>

98 parts by mass of scaly graphite (manufactured by Hitachi Chemical Co., Ltd., average particle size of primary particles: about 450 μm), 1 part by mass of acetylene black, and 1 part by mass of CMC were dispersed in water, and α-alumina scaly particles (new Mohs hardness: 12, aspect ratio D/t: 6.1, average of maximum planer diameters D: 1.0 μm) was further dispersed in the water such that the amount of the α-alumina scaly particles was 2.0 parts by mass with respect to 100 parts by mass of the scaly graphite, thus preparing a negative electrode mixture-containing composition. Except for using this negative electrode mixture-containing composition, a negative electrode was produced in the same manner as in Example 1.

<Preparation of Positive Electrode Mixture-Containing Composition_{>}

93.7 parts by mass of Li_{1.02}Ni_{0.5}Mn_{0.2}Co_{0.3}O₃ as a positive electrode active material (average particle size of primary particles: 15 μm), 4 parts by mass of acetylene black, 2 parts by mass of PVDF and 0.3 parts by mass of polyvinyl pyrrolidone were dispersed in NMP to prepare a positive electrode mixture-containing composition. Except for using this positive electrode mixture-containing composition, a positive electrode was produced in the same manner as in Example 1.

<Production of Lithium-Ion Secondary Battery (Test Cell)>

Except for using the positive electrode and the negative electrode obtained above, a test cell was produced in the same manner as in Example 1.

### Example 6

A negative electrode mixture-containing composition was prepared in the same manner as in Example 5 except that yttria-stabilized zirconia scaly particles (new Mohs hardness: 9.0, aspect ratio DA: 5.6, average of maximum planer diameters D: 0.8 μm, amount of yttria added: 10 mass %) were used in place of the α-alumina scaly particles, and 0.3 parts by mass of the yttria-stabilized zirconia scaly particles were added with respect to 100 parts by mass of the scaly graphite. Except for using this negative electrode mixture-containing composition, a negative electrode was produced in the same manner as in Example 5. And except for using this negative electrode, a test cell (lithium-ion secondary battery) was produced in the same manner as in Example 5.

### Example 7

Zirconium chloride oxide octahydrate was dissolved in water to prepare an aqueous solution with a zirconium salt concentration of 8 mass %. Next, the zirconium salt aqueous solution was dropped into an aqueous solution with an ammonium concentration of 1.4 mass % while stirring the solution to produce a precipitate containing hydrated zirconium oxide particles. The suspension containing the precipitate was matured for 21 hours at ambient temperature. Subsequently, the suspension was put in an autoclave, the temperature of the suspension was raised to 100° C. over 1 hour. Then, the suspension was subjected to a hydrothermal treatment for 7 hours at 100° C., and then was cooled to ambient temperature over 10 hours, followed by maturing for 36 hours at ambient temperature. Next, to remove unreactants and impurities from the hydrothermally-treated precipitate, the suspension was water-washed with an ultrasonic washer, and then was filtered to recover the precipitate. The recovered precipitate was dried for 6 hours at 60° C. in air, and the dried precipitate was cracked slightly with a mortar, thus obtaining hydrated zirconium oxide particles (ZrO₂.5H₂O).

A thermogravimeric differential thermal analysis (TG/DTA) was conducted for the hydrated zirconium oxide particles after a lapse of 1 hour from the end of drying with a differential thermal balance manufactured by Rigaku Corporation (device model: TG-DTA-2000S) to determine n as the amount of hydrated water of the hydrated zirconium oxide particles represented by the general formula ZrO₂.nH₂O.

The powder X-ray diffraction spectrum of the zirconium oxide particles of the hydrated zirconium oxide particles was measured. The results showed that the zirconium oxide particles showed very broad changes in the diffraction intensity within the range of θ=20 to 70° but no clear diffraction line peak was observed, indicating that the zirconium oxide particles had an amorphous structure with undeterminable crystallinity. Further, from TEM images of the hydrated zirconium oxide particles, the average particle size of the primary particles determined by the above-described method was 3 nm and the specific surface area (BET specific surface area) of the primary particles determined by nitrogen gas absorption was 370 m²/g.

The hydrated zirconium oxide particles were added to water in an amount to give 20 mass %, and mixed in a paint shaker for one hour using zirconia beads with a diameter of 0.3 mm, to prepare an aqueous dispersion of the hydrated zirconium oxide particles.

98 parts by mass of scaly graphite (manufactured by Hitachi Chemical Co., Ltd., average particle size of primary particles: about 450 μm), 1 part by mass of acetylene black, and 1 part by mass of CMC were dispersed in 100 parts by mass of water, and yttria-stabilized zirconia scaly particles (new Mohs hardness: 9.0, aspect ratio D/t: 5.6, average of maximum planer diameters D: 0.8 μm, amount of yttria added: 10 mass %) was further dispersed in the water such that the amount of the yttria-stabilized zirconia scaly particles was 0.3 parts by mass with respect to 100 parts by mass of the scaly graphite, thus preparing a dispersion. To 100 parts by mass of the dispersion, 3.5 parts by mass of the aqueous dispersion of the hydrated zirconium oxide particles was added, and they were mixed with a paint shaker for about 15 minutes without using dispersing beads, thus preparing a negative electrode mixture-containing composition containing 0.7 mass % of the hydrated zirconium oxide particles, where the total of the scaly graphite and the hydrated zirconium oxide particles was 100 mass %.

Except for using this negative electrode mixture-containing composition, a negative electrode was produced in the same manner as in Example 5. And except for using this negative electrode, a test cell (lithium-ion secondary battery) was produced in the same manner as in Example 5.

### Example 8

A negative electrode mixture-containing composition was prepared in the same manner as in Example 5 except that yttria-stabilized zirconia scaly particles (_{new} Mohs hardness: 9.0, aspect ratio D/t: 7.1, average of maximum planer diameters D: 5.8 μm, amount of yttria added: 10 mass %) were used in place of the α-alumina scaly particles. Except for using this negative electrode mixture-containing composition, a negative electrode was produced in the same manner as in Example 5. And except for using this negative electrode, a test cell (lithium-ion secondary battery) was produced in the same manner as in Example 5.

### Comparative Example 1

A test cell (lithium-ion secondary battery) was produced in the same manner as in Example 1 except that the same positive electrode as that produced in Example 5 (the positive electrode using no metal oxide scaly particle) was used.

### Comparative Example 2

A positive electrode mixture-containing composition was prepared in the same manner as in Example 1 except that quartz particles (new Mohs hardness: 8, aspect ratio D/t: 3.6, average of maximum planer diameters D: 0.8 μm) were used in place of the yttria-stabilized zirconium scaly particles. Except for using this positive electrode mixture-containing composition, a positive electrode was produced in the same manner as in Example 1. And except for using this positive electrode, a test cell (lithium-ion secondary battery) was produced in the same manner as in Example 1.

### Comparative Example 3

A negative electrode mixture-containing composition was prepared in the same manner as in Example 5 except that α-alumina particles with an indeterminate shape (new Mohs hardness: 12, average particle size: 1.0 μm) were used in place of the α-alumina scaly particles. Except for using this negative electrode mixture-containing composition, a negative electrode was produced in the same manner as in Example 5. And except for using this negative electrode, a test cell (lithium-ion secondary battery) was produced in the same manner as in Example 5.

The load characteristics and the charge-discharge cycle characteristics of each of the test cells of Examples and Comparative Examples were evaluated as follows.

<Load Characteristics>

Each of the test cells of Examples and Comparative Examples was charged at a constant current of 1 C until the battery voltage reached 4.2V, and then was charged at a constant voltage of 4.2V. The time over which each of the test cells was charged at a constant current and a constant voltage was 2 hours in total. Thereafter, each of the test cells was discharged at a current of 0.2 C until the battery voltage became 2.5V and the discharge capacity at 0.2 C was determined.

After being charged under the same conditions as above, each of the test cells was discharged at a current of 3 C until the battery voltage became 2.5V, and the discharge capacity at 3 C was determined. And for each of the test cells, a capacity retention rate was determined by dividing the discharge capacity at 0.2 C by the discharge capacity at 3 C and expressing the obtained value in percentage. It can be said that the larger the capacity retention rate, the better the load characteristics of the test cell.

<Charge-Discharge Cycle Characteristics>

Each of the test cells of Examples and Comparative Examples was charged at a constant current of 1 C until the battery voltage reached 4.2V, and then was charged at a constant voltage of 4.2V. The time over which each of the test cells was charged at a constant current and a constant voltage was 2 hours in total. Subsequently, each of the test cells was discharged at a current of 1 C until the battery voltage became 2.5V. Cycles of charging and discharging were repeated 100 times, where a series of charging at a constant current and at a constant voltage and discharging was taken as one cycle. Then, the value obtained by dividing the discharge capacity at the 100th cycle by the discharge capacity at the 10th cycle was expressed in percentage to determine the capacity retention rate. It can be said that the larger the capacity retention rate, the better the charge-discharge cycle characteristics of the test cell.

Table 1 shows the configurations of the metal oxide scaly particles used for the test cells of Examples and Comparative Examples, and Table 2 shows the results of each of the above evaluations.

TABLE 1

| | Metal oxide scaly particles | | | | |
|---|---|---|---|---|---|
| | | New | Aspect | Average | Content |
| | | Mohs | ratio | of D | (parts by |
| | Type | hardness | D/t | (μm) | mass) |
| Ex. 1 | Yttria-stabilized | 9.0 | 5.6 | 0.8 | 0.3 |
| | zirconia | | | | |
| Ex. 2 | Yttria-stabilized | 9.0 | 4.3 | 2.0 | 1.0 |
| | zirconia | | | | |
| Ex. 3 | Tetragonal | 9.0 | 6.5 | 0.1 | 0.05 |
| | zirconia | | | | |
| Ex. 4 | Yttria-stabilized | 9.0 | 5.6 | 0.8 | 3.0 |
| | zirconia | | | | |
| Ex. 5 | α-alumina | 12 | 6.1 | 1.0 | 2.0 |
| Ex. 6 | Yttria-stabilized | 9.0 | 5.6 | 0.8 | 0.3 |
| | zirconia | | | | |
| Ex. 7 | Yttria-stabilized | 9.0 | 5.6 | 0.8 | 0.3 |
| | zirconia | | | | |
| Ex. 8 | Yttria-stabilized | 9.0 | 7.1 | 5.8 | 2.0 |
| | zirconia | | | | |
| Comp. | — | — | — | | — |
| Ex. 1 | | | | | |
| Comp. | Quarts | 8.0 | 3.6 | 0.8 | 0.3 |
| Ex. 2 | | | | | |
| Comp. | (indeterminate | 12 | — | 1.0 | 2.0 |
| Ex. 3 | α-alumina) | | | | |

For the sake of convenience, the “α-alumina particles” used in Comparative Example 3 are listed in Table 1 along with the metal oxide scaly particles although they had an indeterminate shape, and their average particle size (the average particle size determined by the same method as that used for the low crystalline oxide particles) is shown in the field of Average of D (the maximum planer diameter).

TABLE 2

| | Load | Charge-discharge |
|---|---|---|
| | characteristics | cycle characteristics |
| | (%) | (%) |
| Ex. 1 | 51.2 | 96.9 |
| Ex. 2 | 50.3 | 95.1 |
| Ex. 3 | 50.7 | 96.4 |
| Ex. 4 | 50.6 | 95.2 |
| Ex. 5 | 50.2 | 96.3 |
| Ex. 6 | 52.0 | 97.5 |
| Ex. 7 | 53.1 | 98.9 |
| Ex. 8 | 50.3 | 96.1 |
| Comp. Ex. 1 | 49.2 | 94.0 |
| Comp. Ex. 2 | 49.0 | 94.5 |
| Comp. Ex. 3 | 47.9 | 95.1 |

As can be seen from Tables 1 and 2, the test cells of Examples 1 to 8, each of which had a positive or negative electrode containing metal oxide scaly particles with adequate hardness, had excellent load characteristics, and their charge-discharge cycle characteristics were also favorable.

In contrast, for the test cell of Comparative Example 1 having positive and negative electrodes containing no metal oxide scaly particle, the test cell of Comparative Example 2 having a positive electrode containing metal oxide particles with small hardness, and the test cell of Comparative Example 3 having a negative electrode containing metal oxide particles having an indeterminate shape, their load characteristics were inferior to those of the test cells of the Examples. Further, the test cells of Comparative Examples 1 and 2 also had inferior charge-discharge cycle characteristics to those of the test cells of the Examples.

### Example 9

A negative electrode mixture-containing composition was prepared in the same manner as in Example 6 except that 94 parts by mass of scaly graphite and 4 parts by mass of SiO-carbon composite (composite obtained by coating the surface of SiO with carbon by CVD; mass ratio of SiO to carbon on the surface=85:15; average particle size of primary particles of SiO: 4.9 μm) were used as negative electrode active materials in place of 98 parts by mass of scaly graphite. Except for using this negative electrode mixture-containing composition, a negative electrode was produced in the same manner as in Example 5. And except for using this negative electrode, a test cell (lithium-ion secondary battery) was produced in the same manner as in Example 5.

### Comparative Example 4

A negative electrode mixture-containing composition was prepared in the same manner as in Example 1 except that 94 parts by mass of scaly graphite and 4 parts by mass of SiO-carbon composite (composite obtained by coating the surface of SiO with carbon by CVD; mass ratio of SiO to carbon on the surface=85:15; average particle size of primary particles of SiO: 4.9 μm) were used as negative electrode active materials in place of 98 parts by mass of scaly graphite. Except for using this negative electrode mixture-containing composition, a negative electrode was produced in the same manner as in Example 1. And except for using this negative electrode, a test cell (lithium-ion secondary battery) was produced in the same manner as in Example 5. That is, the test cell of Comparative Example 4 was an example of a test cell containing no metal oxide scaly fine particle in both the positive electrode and the negative electrode.

The load characteristics and the charge-discharge cycle characteristics of the test cells of Example 9 and Comparative Example 4 were evaluated in the same manner as the test cell of Example 1. Table 3 shows the configurations of the metal oxide scaly particles used for the test cells of Example 9 and Comparative Example 4, and Table 4 shows the results of each of the above evaluations.

TABLE 3

| | Metal oxide scaly particles | | | | |
|---|---|---|---|---|---|
| | | New | Aspect | Average | Content |
| | | Mohs | ratio | of D | (parts by |
| | Type | hardness | D/t | (μm) | mass) |
| Ex. 9 | Yttria-stabilized | 9.0 | 5.6 | 0.8 | 0.3 |
| | zirconia | | | | |
| Comp. | — | — | — | — | — |
| Ex.4 | | | | | |

TABLE 4

| | Load | Charge-discharge |
|---|---|---|
| | characteristic | cycle characteristic |
| | (%) | (%) |
| Ex. 9 | 61.9 | 93.2 |
| Comp. Ex. 4 | 59.7 | 89.6 |

Example 9 and Comparative Example 4 were examples of test cells using a SiO-carbon composite as a negative electrode active material along with graphite. Even in these cases, the test cell of Example 9 having a negative electrode containing metal oxide scaly particles with adequate hardness had better load characteristics and charge-discharge cycle characteristics than those of the test cell of Comparative Example 4 having positive and negative electrodes containing no such metal oxide particle.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

The lithium-ion secondary battery of the present invention can be used in a variety of applications to which conventionally-known lithium-ion secondary batteries have been applied.

1. An electrode for a lithium-ion secondary battery, comprising an electrode mixture layer including metal oxide particles having a scaly shape and a new Mohs hardness of 9.0 or more, active material particles capable of intercalating and deintercalating Li, and a resin binder.

2. The electrode according to claim 1, wherein a content of the metal oxide particles in the electrode mixture layer is 0.01 to 2 parts by mass with respect to 100 parts by mass of the active material particles.

3. The electrode according to claim 1, wherein at least a part of the metal oxide particles is present in the resin binder.

4. The electrode according to claim 1, wherein the metal oxide particles have an aspect ratio D/t of 4 or more, where the aspect ratio D/t is represented by a ratio of a maximum planer diameter D (μm) and a thickness t (μm) of the metal oxide particles.

5. The electrode according to claim 1, wherein an average of the maximum planer diameters D (μm) of the metal oxide particles is 0.1 to 5 μm.

6. The electrode according to claim 1, wherein the metal oxide particles are particles of at least one metal oxide selected from the group consisting of α-aluminum oxide, tetragonal or cubic zirconium oxide, and metal oxide obtained by stabilizing α-aluminum oxide, tetragonal zirconium oxide or cubic zirconium oxide with a stabilizer.

7. The electrode according to claim 6, wherein the metal oxide of which the metal oxide particles are made is stabilized with at least one stabilizer selected from the group consisting of magnesium oxide, calcium oxide, and yttrium oxide, and an amount of the stabilizer added to the metal oxide is 15 mass % or less.

8. A lithium-ion secondary battery comprising a positive electrode, a negative electrode, a nonaqueous electrolyte and a separator,
wherein the positive electrode and/or the negative electrode is the electrode according to claim 1.
